(19) United States
(12) Patent Application Publication
(10) Pub. No.: US 2007/0214262 A1
(43) Pub. Date: Sep. 13, 2007

(54) Personal server technology with firewall detection and penetration

(75) Inventors: John E. Buchbinder, Orinda, CA (US); Alan D. Finke, Pleasanton, CA (US); Joshua E. Buchbinder, Orinda, CA (US)

Correspondence Address: DERGOSITS & NOAH LLP, FOUR EMBARCADERO CENTER, SUITE 1450, SAN FRANCISCO, CA, 94111, US

(73) Assignee: ANYWHEREMOBILE, INC.

(21) Appl. No.: 11/801,352

(22) Filed: May 8, 2007

Related U.S. Application Data
(63) Continuation-in-part of application No. 10/077,105, filed on Feb. 15, 2002.
Application No. 10/077,105 is a continuation-in-part of application No. 09/513,550, filed on Feb. 25, 2000, now abandoned.

(51) Int. Cl. G06F 15/173

(52) U.S. Cl. 709/224

(57) ABSTRACT

A first personal server within a firewall protected network initiates communications with a connection server that is coupled to a network of remote clients that can remotely access the first personal server. A series of tests using communication protocols of increasing complexity are executed until a communication protocol enabling communication between the first personal server and connection server is determined. If the address of the first personal server changes upon connection, the connection server registers the new address upon each change. If the connection between the first personal server and connection server is unintentionally broken, the first personal server re-establishes contact with the connection server and maintains the connection by transmitting periodic signals to the connection server. The connection server is capable of connecting many remote devices to their associated personals servers.

### CROSS-REFERENCE TO RELATED APPLICATIONS

This application is a continuation-in-part application of U.S. application Ser. No. 10/077,105, entitled “PERSONAL SERVER TECHNOLOGY WITH FIREWALL DETECTION AND PENETRATION” filed on Feb. 15, 2002 which is a continuation-in-part of U.S. application Ser. No. 09/513,550, entitled “PERSONAL SERVER TECHNOLOGY”, filed on Feb. 25, 2000.

### FIELD OF THE INVENTION

The present invention relates generally to computer device networks, and more specifically to a wireless local area network that integrates home appliances, computing devices, and other objects into a coordinated wireless control and monitoring network, and that provides penetration of protection mechanisms within the local area network.

### BACKGROUND OF THE INVENTION

Systems that monitor and control electronic appliances and other objects in the home and office are known. Such systems, however, are limited almost exclusively to “remote control” systems involving the use of a hand-held device to send instructions directly to and receive information directly from one, or at most a few, objects. One example of such a remote control device is the standard VCR (video cassette recorder) remote, which operates on infrared (IR) light wavelengths. A VCR remote is typically used to program recording parameters into a VCR and to operate the VCR in real-time. Similar remote control devices exist for TVs, CD players and other appliances. Lights and other household fixtures can also be controlled by remote, usually by installation of a component that allows for simple commands such as on/off and dimming in response to hardwired timers, audible input, or other control means.

However, the state of remote control of home appliances and electronic equipment in the current art is nascent. Some objects such as VCRs and CD (compact disk) players usually have remote control devices, but many do not. Even among the objects that do have remote control, such objects are not controlled through integrated networks. In fact, the notion of a connectivity system or solution hardly applies to the state of the current art. Of the relatively few objects in a present-day home or office that can be controlled by remote, each one generally requires a separate remote control device. Sometimes, a handful of objects (e.g., CD player, amplifier and tuner) can be controlled with a single remote from a single manufacturer of the devices, or they can be standardized to a single “universal” remote that can control a large number of TVs and VCRs.

Some present systems include home control systems that allow a user to control lights, sound systems, and other fixtures throughout the household. While appearing to be along the lines of a true “control network,” these systems still exhibit only rudimentary control over and feedback from objects that are connected to the network. In addition, these systems are difficult to implement, and do not offer the power and flexibility of a programmable, software-based network. They also cannot be controlled and monitored from outside the home via network and Internet connections.

The true networks that do exist in the current art are essentially limited to information exchange. For instance, U.S. Pat. No. 5,809,415, issued to Rossmann, which is herein incorporated by reference in its entirety, describes a two-way, portable data-communication device that allows user access to a wide-area network, such as the Internet. Such inventions are limited in the opposite way that home-control and remote-control systems are limited. The former cannot manipulate and monitor the physical devices, at least not to any appreciable degree, while the latter lack the information, control and integration aspects of a true network.

For these reasons, among others, there is a need in the art for a true network that can bring a large number of objects under the control of a single, integrated connectivity solution. This solution would ideally be flexible enough to be easily programmed for different network configurations and settings, and powerful enough to allow the user to have precise control and perception of the objects in the network through the metaphor of an intuitive user interface.

A further disadvantage associated with present systems for networking home control systems is the inability to effectively accommodate network security structures, such as firewalls and other network filters. In a computer network, a firewall can be implemented as a single router that filters out unwanted communication packets, or it may comprise a combination of routers and servers each performing some type of firewall processing. Firewalls are widely used to give users secure access to the Internet and to keep internal network segments secure. However, in certain situations, these firewalls also prevent desired access from one network to another. Present systems of networking devices in a home control environment generally cannot penetrate firewall protected networks. This limits the use of present home control environments from effectively allowing access and control to other networks, such as the Internet.

Although generic firewall bridge systems do exist for allowing network access through firewall protected computers, these systems typically require the implementation of a Virtual Private Network (VPN), or private dedicated lines necessary for security. The use of VPN technology is generally disadvantageous because implementation is often difficult and expensive, and requires high maintenance. Present VPN systems also suffer from the drawback of generally not working with Personal Digital Assistant (PDA) devices, thus limiting their effectiveness in wireless network systems.

### SUMMARY OF THE INVENTION

A connectivity system for use in the home, office and other locations that incorporates a method of penetrating firewall protection schemes is described. The system comprises a server-like apparatus that integrates home appliances, entertainment systems, computing devices, and other objects into a coordinated wireless control and monitoring network. A remote device is used to control and monitor these objects via the functioning of the server-like apparatus. The server-like apparatus is also connected to other networks, such as the Internet. The remote device presents the user with a powerful, easy-to-use interface environment that intuitively maps to the objects on the network and the actions and activities being performed. The present invention thus implements an automated, intelligent, seamlessly connected “home or office of the future.”

The present invention offers an integrated connectivity solution for remote control of various network integrated household and office objects (“Controlled Devices”). It comprises a software-based network that can perform information-heavy tasks and that incorporates sophisticated object monitoring and control, as well as computational activities, into the network. The present invention consists of a server-like apparatus (“Personal Server”) that controls a network, and performs computational tasks, in the home, office, or other location. The Personal Server is accessed through a Remote Device, generally a hand-held, personal digital assistant (“PDA”), a data-enabled telephone or cellular phone (“SmartPhone”), or some form of internet access device. PALM O/S™ devices such as the PALM PILOT™, PALM III™ and PALM IV™, and WINDOWS CE™ devices such as the PHILIPS NINO™, CASIO CASSIOPEIA™ and HP JORDANA™ are common PDAs that are readily adaptable for use with the present invention. The Qualcomm PdQ phone, a cellular phone with digital computing and display capabilities, is an example of a SmartPhone that will work well with the present invention.

Embodiments of the present invention allow users to control and monitor various Controlled Devices. These functions can be accomplished from within the location where the Personal Server is located, or from the outside world thorough a dial-up connection, network, or the Internet, or other means. Remote information tasks, such as file exchange, computational activity and financial transactions can also be carried out by the Personal Server, using a Remote Client operating on a Remote Device as the interface. Third parties, such as alarm companies and police departments, can be given full or partial access to the monitoring and control functions of the Personal Server.

Embodiments of the present invention also allow penetration of firewalls and other protection devices between the Personal Server and the Controlled Devices. A connection module within the Personal Server establishes communication with a Connection Server, which is directly or indirectly coupled to one or more Controlled Devices. The connection module determines the type of firewall that exists between the user computer and the Personal Server. Protection protocols of increasing complexity are tested until the type of firewall is determined. This protocol is then used for subsequent communication. If the address of the Personal Server is dynamic, the Personal Server registers its new address with the Connection Server upon each connection. The Connection Server then tracks the address of the user computer. If the connection between the Connection Server and Personal Server is unintentionally broken, the Personal Server re-establishes communication, and transmits periodic “keep alive” signals to the Connection Server to maintain the connection.

The inventive system is intended to be used in a configuration that allows a single Connection Server to facilitate the communications between many Personal Servers and their corresponding Remote Devices. Thus, communications between a first Remote Device and a first Personal Server through the Connection Server are completely isolated and secure from communications between a second Remote Device and a second Personal Server through the Connection Server.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a personal server, including Action Modules, Scheduler/Router, and Input/Output Modules, according to one embodiment of the present invention;

FIG. 2 illustrates some examples of the physical connection and data transfer protocols that can be used between the Remote Device and the Personal Server;

FIG. 3 shows a control panel that is used to configure the network of objects on the Personal Server, according to one embodiment of the present invention;

FIGS. 4A and 4B show an example of a screen on the Remote Client interface running on the Remote Device that can be used in conjunction with embodiments of the present invention;

FIG. 5 shows an embodiment of Home Pad on a more graphically limited Remote Device, namely, a cell phone;

FIG. 6 shows a second example of a screen on the Remote Client interface running on the Remote Device used with the present invention, in this case, Credit Pad;

FIG. 7 shows a third example of a screen on the Remote Client interface running on the Remote Device used with the present invention, in this case, File Retriever;

FIG. 8A illustrates a Personal Server network that includes a firewall detection and penetration scheme, according to one embodiment of the present invention;

FIG. 8B illustrates a Personal Server network that includes a firewall detection and penetration scheme, according to an alternative embodiment of the present invention;

FIG. 9 is a flowchart that illustrates the method of identifying the presence of a firewall and establishing a communication conduit between a Personal Server and a Connection Server coupled to a Remote Device, according to one embodiment of the present invention; and

FIG. 10 illustrates a Personal Server network that includes a firewall detection and penetration scheme, according to one embodiment of the present invention.

### DETAILED DESCRIPTION OF THE PREFERRED EMBODIMENT

A wireless personal server for interfacing a variety of home appliance and computing devices in a firewall protected network environment is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network, standard telephone line, or wireless data link. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

In a preferred embodiment, the core of the present invention is a server-like apparatus (“Personal Server”). The Personal Server comprises software run on a general-purpose computer. The computer can be a server, workstation, dedicated hardware device, or any other type of computer. In the description that follows, it is assumed that the computer comprising the Personal Server is a desktop PC. In other embodiments, the Personal Server comprises hardware specifically designed for the invention, or a combination of hardware and computer software. The software can be a component bought off the shelf, a component specially designed for a particular home or office, a plug-in to a software developer's kit, or part of a larger proprietary system, among other embodiments. The software of the Personal Server is typically written in C, C++ or Java™. The Personal Server is designed to have a robust and flexible interface that makes it easy for developers to develop Input/Output and Action Modules that operate with the present invention.

1. Software Architecture

a. Personal Server

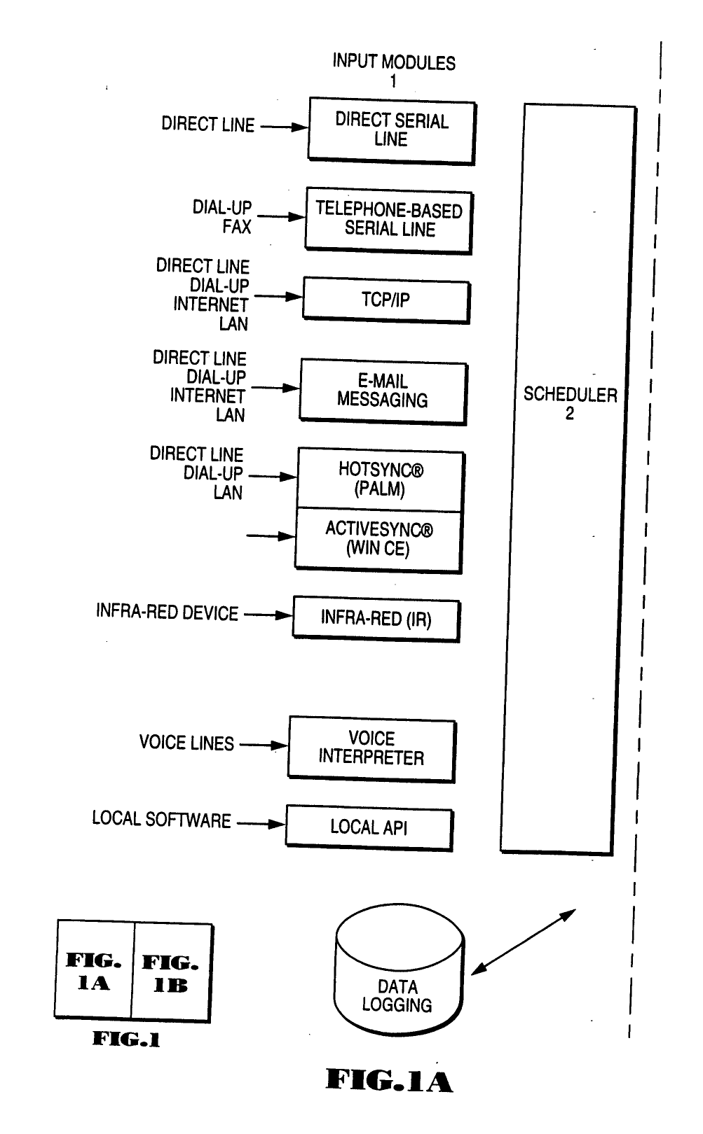

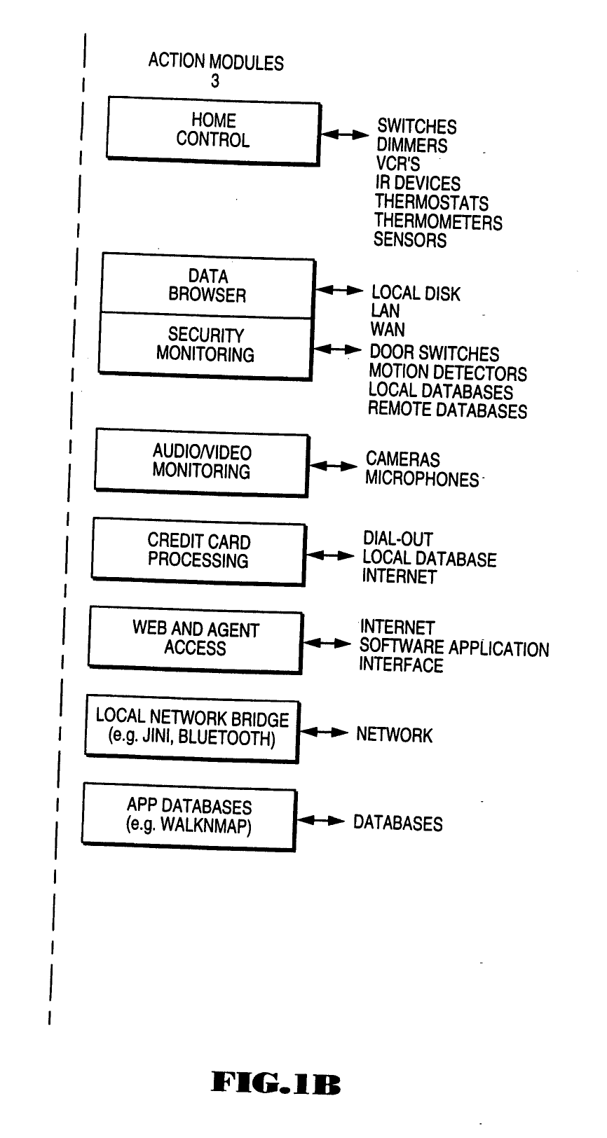

The following is a preferred embodiment of the software architecture of the present invention. FIG. 1 illustrates a further preferred embodiment, in detail.

The Personal Server has a software architecture that consists of the following components: Input/Output Modules 1, a core Scheduler/Router 2 with data logging capabilities and Action Modules 3. The Input/Output Modules 1 and Action Modules 3 are self-contained code libraries designed to be detected by the Scheduler/Router 2 and connected at run-time. This architecture allows developers and consultants to develop additional modules, either for a class of users or Controlled Devices, or on a case-by-case basis for specific individual users, to fit those users needs. In particular, as new forms of communication, types of Controlled Devices, and activity are developed through technological development and commercial innovation, new types of modules will be developed. Such modules can be added to the Personal Server by direct installation or by downloading on an ad-hoc basis from remote sources. They can also be dynamically added to individual installations of the Personal Server, with or without user intervention, to minimize service interruption.

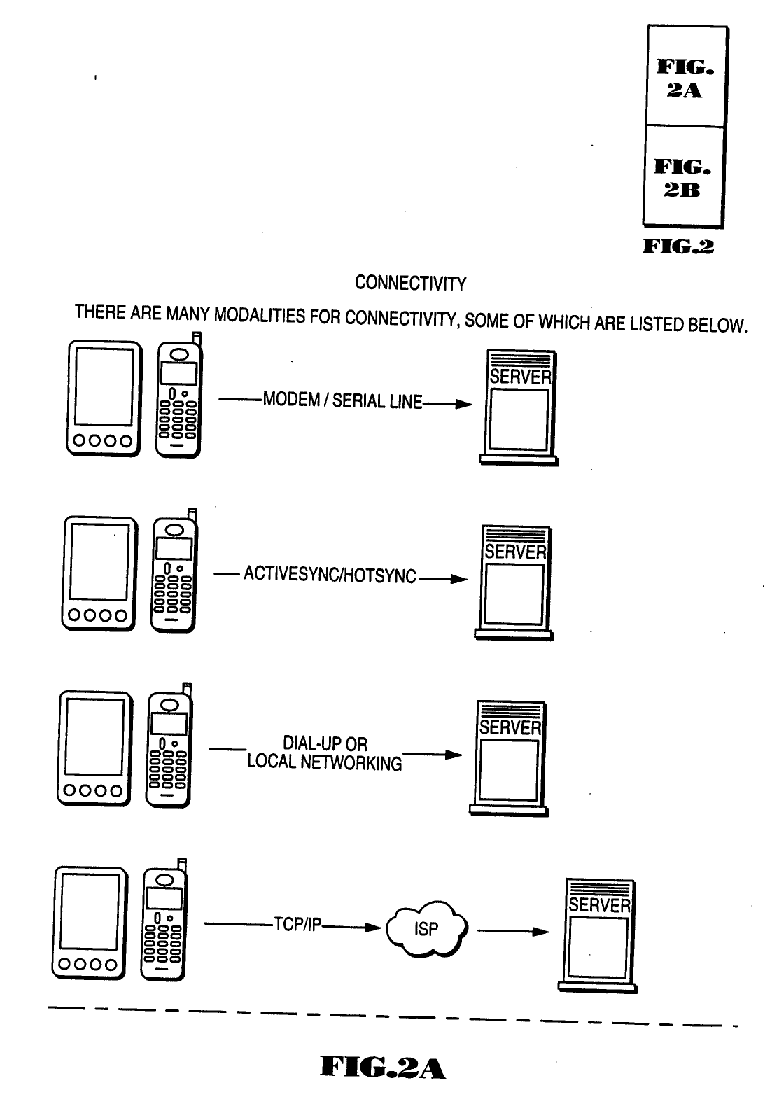

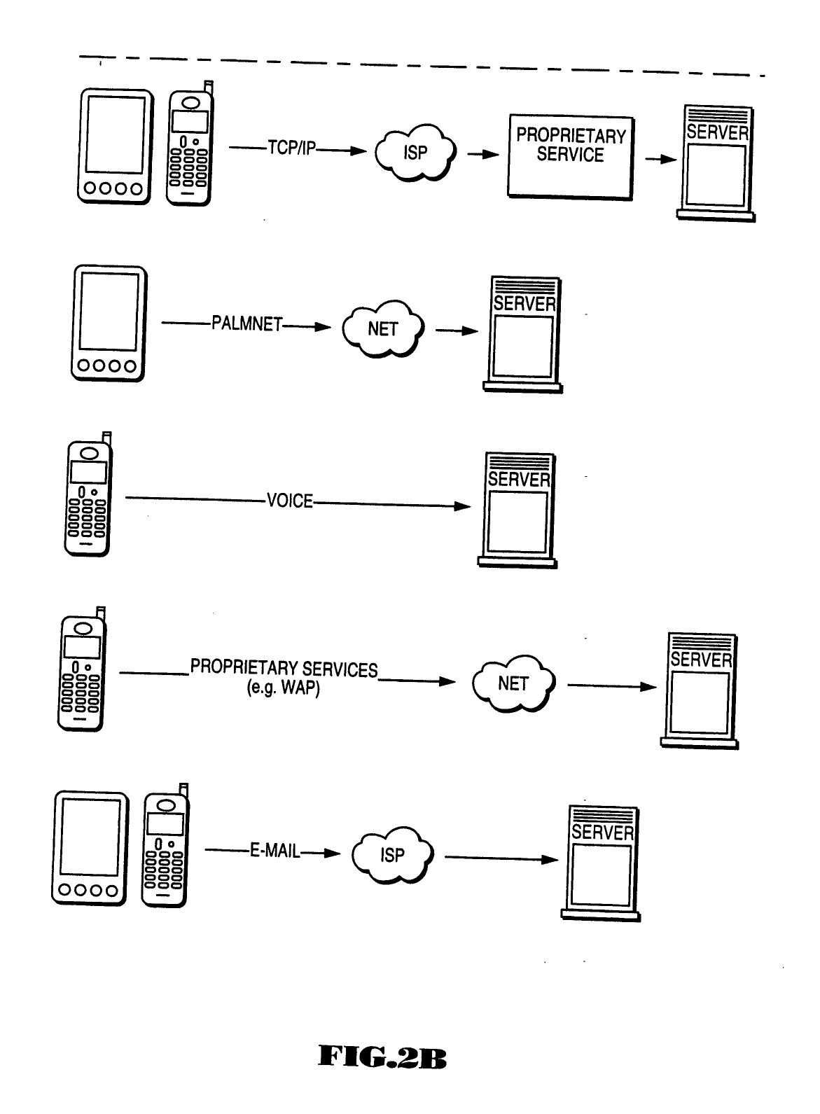

Input/Output Modules 1 serve to connect a user's Remote Device to the Personal Server, but they can be designed for other modes of communication as well. Various types of physical connections and data-transfer protocols can be used, as illustrated in FIG. 2. At synchronization, the Remote Device sends the information entered by the user to an Input/Output Module or Input/Output Modules. This information is translated into a “Message” by the Input/Output Module. Messages generally contain information on the user, the Remote Device, the target Action Module and data specifics. The Message may be encoded or encrypted for the purpose of data security. In one encryption scheme, Messages are encrypted by the Remote Device prior to transmission, and then decoded by the Input/Output Module. The Input/Output Module then passes the Message to the Scheduler/Router, which logs it into a database, processes it as necessary, and passes the Message again to the appropriate Action Module. The Action Module then performs the requested actions. After the action has been completed, the Action Module creates a second Message containing user-requested information, results of calculations or computations, information on whether the action has been successfully completed, date and time stamps, and whether additional instructions are needed. The Action Module passes the Message to the Scheduler/Router, which logs it, processes it as necessary, and passes it, if necessary, to the Input/Output Module. The Input/Output Module then communicates the Message contents, possibly in encrypted format, to the Remote Device. Additional messages not specifically mentioned may be created and sent as particularly in other embodiments. Alternate embodiments employ separate Input Modules and Output Modules rather than combined Input/Output Modules. In such alternate embodiments, Input Modules are responsible for receiving Messages from the Remote Device, whereas Output Modules are responsible for sending Messages to the Remote Device.

At start-up, the Scheduler/Router loads the existing Input/Output Modules and Action Modules and monitors them for activity. As noted, the Scheduler/Router processes and relays Messages between the Input/Output and Action Modules. It maintains information on user identification, user password and security information, as well as logs of the Messages. In a preferred embodiment, a Utility Module is written as an adjunct to the Scheduler/Router, which allows the user to enter settings. The Utility Module will generally have a control-panel type interface to aid in configuring new user preferences and new modules.

The Action Modules or the Scheduler/Router may initiate messages to the user. If the user has requested an action to be performed that may take a long time, the user may disconnect and request that the results be sent back at a later time. Alternately, a Controlled Device may initiate a communication, triggering an Action Module to send a Message to the Scheduler/Router. In this way, the user may configure the system so that the Personal Server initiates communication when triggered by an event such as a home alarm being set off. Results may be sent back when the user connects again, by a connection established by the Personal Server, or by another communication means such as pager, telephone, fax, or e-mail.

b. Input/Output Modules

As described in the section above, Input/Output Modules 1 serve as connection points between the Personal Server and the Remote Device. The various Input/Output Modules in place with a particular embodiment of the Personal Server are designed to handle various connectivity and data-transfer protocols (some examples of which are listed in FIG. 2). In a preferred embodiment, proprietary PDAs protocols such as HOTSYNC™ (for PALM OS™ devices) and ACTIVESYNC™ (for WINDOWS CE™ devices) are among these protocols. In the case of incoming Messages an Input/Output Module communicates with a Remote Device by synchronizing with the Remote Device, receiving and interpreting a Message from the Remote Device, optionally decrypting the Message if it is in encrypted form, and then passing the Messages on to the Scheduler/Router which in turn optionally passes that Message in original or modified form on to an Action Module and possibly a Controlled Device. In the case of outgoing Messages an Input/Output Module communicates with a Remote Device by synchronizing with the Remote Device, receiving and interpreting a Message from the Scheduler/Router (which Message may have originated from a Controlled Device or Action Module), optionally encrypting the Message, and then passing the Messages on to the Remote Device, which in turn decrypts the Message as necessary.

In alternate embodiments connection to the Input/Output Modules may be mediated by an Internet service designed specifically to communicate with the Personal Server, or else to a general-purpose Internet service (the “Service”). The user operating the Remote Device may log in or otherwise connect to the Service. In either event, the user accesses a network server (the “Internet Server”) which runs the Service via a website or other user interface. Once the user has logged in using a Remote Device, the Service will then complete the final link to the Personal Server. The Service may dial-in, or use any of the means of connectivity supported by the Input/Output Modules, and then communicate with the Personal Server using standard protocols. The Messages from the Personal Server are then communicated back to the user. Thus a user can use a Remote Device such as a Web-enabled cellular phone to connect to a Personal Server at home or at the workplace.

In alternate embodiments there may be no encryption provided, or the encryption/decryption function may occur at different locations on the system such as at the Scheduler/Router, Action Module, or Controlled Device rather than or in addition to the encryption provided by the Input/Output Module. In other alternate embodiments encryption/decryption functions may occur at the level of the Remote Client or the Service rather than or in addition to the encryption provided by the Remote Device.

c. Action Modules

The Action Modules are the software objects that actually carry out instructions specified by the user, and that obtain status and other information from and send instructions to the Controlled Devices. Because of the wide variety of specific actions they carry out, Action Modules will often include their own databases to assist in their functions. Some Action Modules will have their own connectivity to the Web and to other communication lines. An Action Module may be connected to a third party or parties, to the Internet, to other computer systems, or to other networks (even other Personal Server networks).

d. Messages

In a preferred embodiment Input/Output Module some Messages from the Input/Output Module to the Scheduler/Router comprise user information, intended Action Module or modules, message length, time stamp and data specifics. The data specifics contain specific commands to the Action Module or Action Modules such as requests for state information as well as any data needed by the Action Module to perform its tasks.

Messages from the Scheduler/Router to the Input/Output Module comprise user information, Action Module identification, message length, time stamp, and data specifics. The data specifics contain responses requested by the user, the results of actions performed, state information, response formatting information, and possible requests for additional information from the input device.

In alternate embodiments, Messages may originate or terminate, or be interpreted, parsed, decoded, encoded, modified, scheduled, or otherwise processed by the Remote Client, the Remote Device, the Service, the Input/Output Module, the Scheduler/Router, the Action Module, or the Controlled Device. New Input/Output Modules and message protocols can be developed by one of ordinary skill in the art as new technologies, in particular O/S device types, are developed.

e. Remote Client/Remote Device

The Remote Client is the user's interface and architecture for the Personal Server. It resides on the Remote Device as a data-gathering/presentation medium. The Remote Device, in a preferred embodiment, is a handheld PDA such as a PALM O/S™ WINDOWS CE™ device, or SmartPhone. In alternate embodiments the Remote Device may be a desktop personal computer or any form of Internet access device. Since many Remote Devices, especially handheld devices, are limited in terms of processing power, memory and display capabilities, the Remote Client is generally designed with these limitations in mind. Therefore, in a preferred embodiment, the software architecture of the present invention relies most heavily on the Personal Server itself, rather than on the Remote Client. In some embodiments, a laptop or even desktop computer will act as the Remote Device, often connected through a network, such as the Internet, but even in these cases, the degree of input available from the computer may be limited. In addition, a web page served by a mediating Service on the Internet may serve as the interface for communication to the user. This allows limited input through an Internet access device such as a SmartPhone or Internet kiosk.

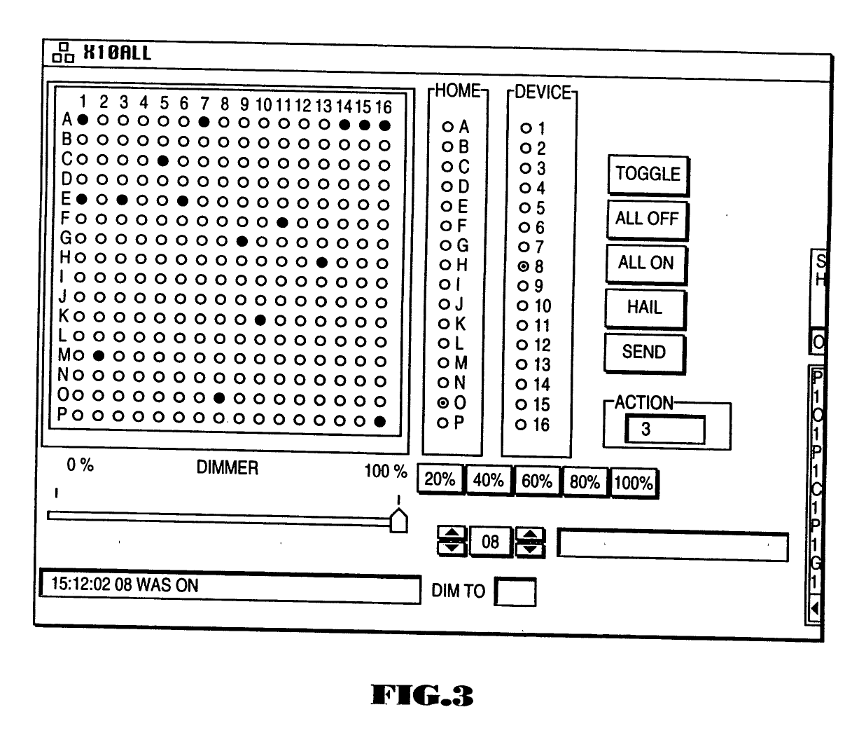

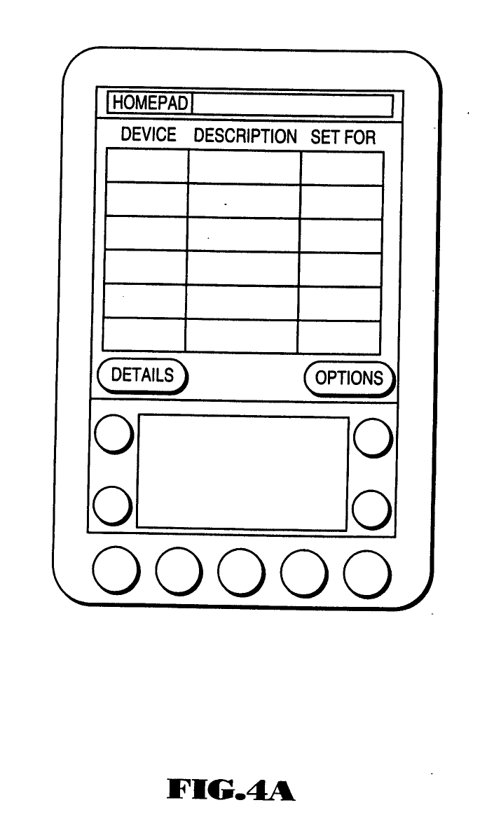

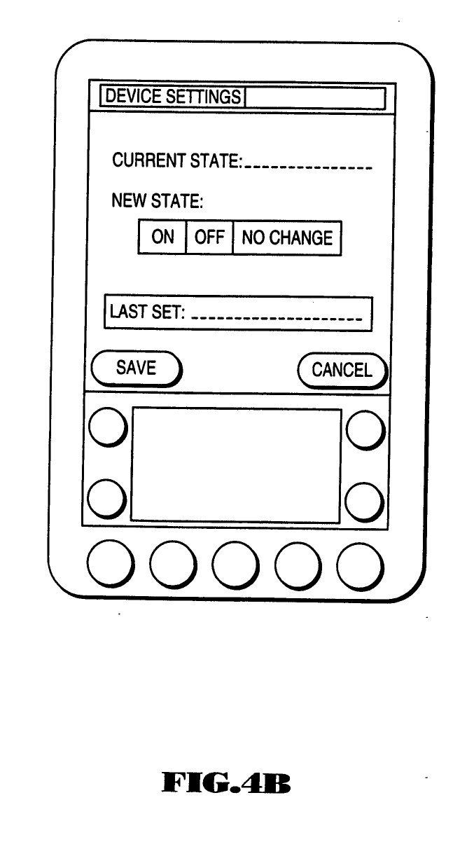

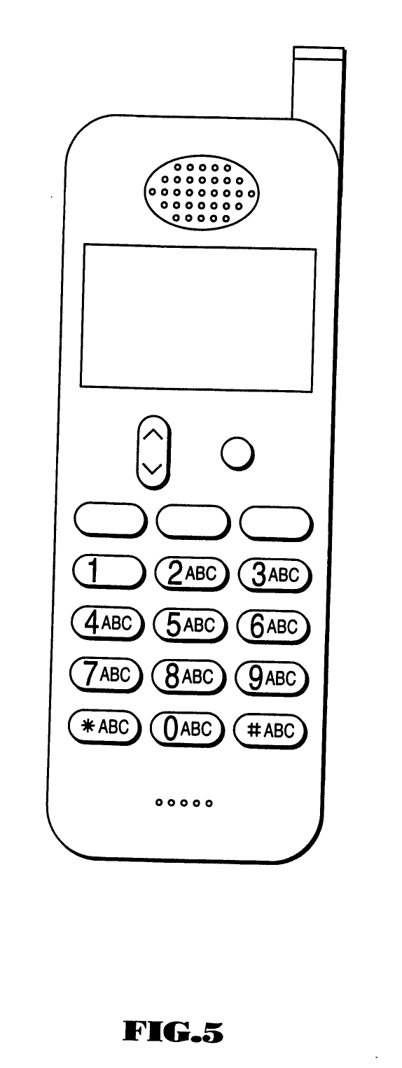

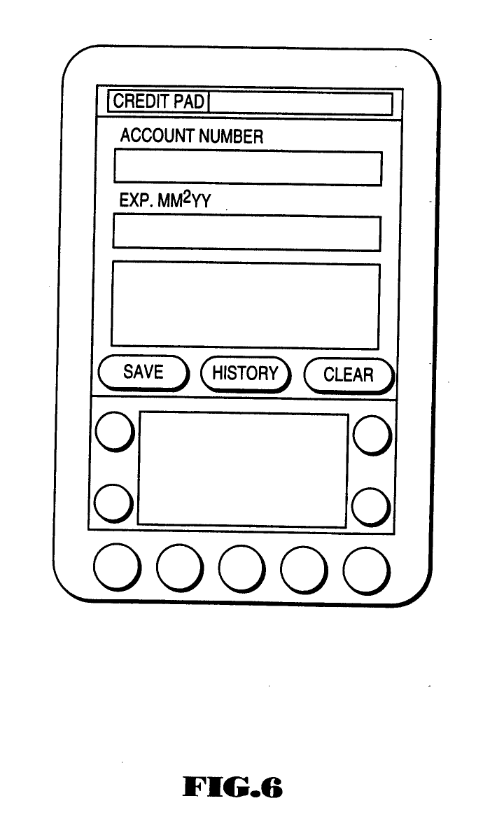

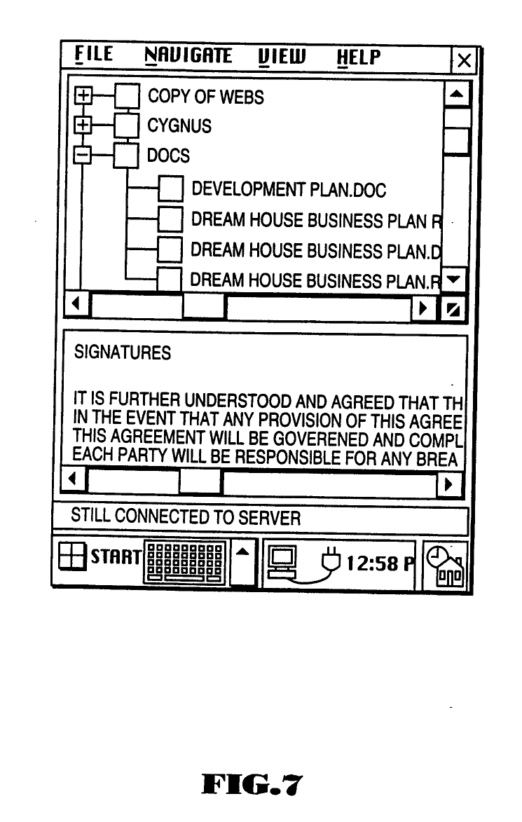

The Remote Client presents an environment that precisely maps to the network of objects to be controlled through the Personal Server, thus allowing seamless control and perception over the network. The Remote Client has the appropriate interfaces, which communicate with the Input/Output Modules of the Personal Server. The Remote Client is generally designed with the most minimal interface environment that nonetheless remains clear and intuitive to the user. FIGS. 4-6 illustrate sample Remote Client environments, including Home Pad, Credit Pad and File Retriever (see “Brief Description of Drawings”). While somewhat less complex than an environment on the Personal Server itself, such as the X10 control interface of FIG. 3, Remote Client environments nonetheless remain robust and easy to use.

The Remote Client also generally uses the minimum amount of encryption and authentication necessary to preserve security. Remote Devices, particularly third-party Remote Devices, will generally be programmed to operate as the Remote Client. Some Remote Devices will be adapted with additional hardware to operate as the Remote Client, and some will be manufactured specifically for use with the present invention.

Remote Devices may use a variety of physical connection and data transfer protocols to communicate with the Personal Server, some examples of which are illustrated in FIG. 2. Typically more than one protocol will be available, depending on where the user and the Remote Device happen to be at the time of linking. The following is another way of categorizing the types of connections:
1. Through the same wireless network that is used to control objects in the home or office (used when the user is in or near that home or office)
2. Through a different wireless network
3. Through a direct wire-based or wireless connection, such as a serial computer interface (used when the Remote Device is “plugged-into” the Personal Server for data transfer or programming
4. Through a dial-in modem connection
5. Through a dial-up service, Internet service, or other mediating Service on the Internet or other Wide-Area networks

Traditional phone lines, leased lines and satellite connections are among the communication pipes that can be used to support these physical connections. In some cases, it will be desirable for the user to authorize third-party access to some or all of the control and monitoring systems of the Personal Server. For instance, a user may allow an alarm company to monitor the alarm system. The user may also wish to give some access to a family member or friend if the user is on vacation or otherwise indisposed.

2. Method

a. Direct Connection.

The following flowchart illustrates, as a preferred embodiment, the method of using a device constructed in accordance with the present invention to carry out a typical task, such as programming a VCR.
1. The user enters information concerning the desired action into the Remote Device via the Remote Client
2. The Remote Device stores the information
3. The user synchronizes the Remote Device by indicating to the Remote Client that the information should be transmitted
4. The Remote Device dials into the Personal Server via cellular modem
5. The Personal Server's Input/Output Module receives the phone call
6. The Input/Output Module uploads the information from the Remote Device, creates a Message, and alerts the Scheduler/Router
7. The Scheduler/Router determines that the Message is intended for the VCR Action Module
8. The Scheduler/Router passes the message to the VCR Action Module, which parses the Message and in turn sends appropriate instructions to the VCR
9. The VCR Action Module sends a new Message to the Scheduler/Router, confirming that the action was or was not taken, among other status details
10. The Scheduler/Router logs, processes and passes the new Message to the appropriate Input/Output Module
11. The Input/Output Module responds to the Remote Device, if necessary, reestablishing the connection if necessary
12. The Remote Device displays relevant status information to the user via the Remote Client
13. The Input/Output Module hangs up the modem connection as necessary
   b. Network-Mediated Connection.

The following flowchart illustrates, as an alternate embodiment, the method of using a device constructed in accordance with the present invention to carry out a typical task using the Internet as an intermediary communications mechanism. The user accesses and logs onto the Service using the Remote Client running on the Remote Device.
1. The Service presents the Remote Client with a Web page designed as an interface for programming a VCR
2. The user enters the appropriate information and indicates that the data is complete
3. The Service dials into the Personal Server via dial-up or other connectivity
4. The Personal Server Input/Output Module receives the call
5. The Input/Output Module uploads the information from the Service, creates a Message, and alerts the Scheduler/Router
6. The Scheduler/Router determines that the Message is intended for the VCR Action Module
7. The Scheduler/Router passes the message to the VCR Action Module, which in turn parses the message and sends appropriate instructions to the VCR
8. The VCR Action Module sends a new Message to the Scheduler/Router, confirming that the action was or was not taken, among other status details
9. The Scheduler/Router logs, processes and passes the new Message to the appropriate Input/Output Module
10. The Input/Output Module responds to the Service, if necessary, reestablishing the connection if need be.
11. The Service creates a Web page displaying relevant status information to the user via the Remote Client
12. The Input/Output Module closes the connection to the Service.

Either of the above flowchart embodiments may be applied, with modifications, to the control and monitoring of objects other than the VCR, and to other system embodiments described herein.

3. Functionality

The Personal Server is designed to carry out three functions, among others: control, monitoring and remote information tasks. Other functions are obvious to one of ordinary skill in the art. The Personal Server is typically used to control and monitor the following types of Controlled Devices: remote-ready objects, non-remote-ready objects and other objects. Many Controlled Devices will have both control and monitoring aspects to them, (e.g. “is the porch light on?” “turn on the porch light”), though some will have relatively more of one type of functionality than the other. As an example, VCR's have relatively more control functions, relating to programming the VCR, than monitoring/status functions.

Typically, within the home or office, the Personal Server and its Controlled Devices will operate on a wide area network (“WAN”) or local area network (“LAN”). In a preferred embodiment, Intel's BLUETOOTH™ is the hardware standard and protocol used to put together the network. Many other hardware and protocol implementation are obvious to one of ordinary skill in the art. In general, communication nodes will be used to broadcast the network signals to Controlled Devices on the network. For example, in one embodiment, X10 stations are used with the present invention to broadcast the signals.

a. Remote-Ready Objects

Remote ready Controlled Devices are appliances that are already remote-capable. These objects typically include VCRs, TVs, CD players, home or office security systems, and other sophisticated electronic devices that normally come with remote capability (generally using infra-red signals, in the current art). In addition, there are many standard household controls such as light switches, thermostats, garage doors, and alarm systems that are designed specifically for home-automation purposes. The Personal Server takes advantage of such remote capability to communicate with these devices. Many Controlled Devices use standardized communication protocols, which makes it a straightforward matter to communicate with these devices (“universal” remotes, for instance, take advantage of these standards). The Personal Server can be programmed with additional Input/Output Modules to allow for communication with non-standard objects, however. Input/Output Modules may be developed by value-added providers to enable the Personal Server to communicate with new and non-standard devices as they are developed.

As a further illustration, consider the activity of programming a VCR, discussed in the above section on overall architecture. The user, could, of course, program the VCR directly via the VCR console or remote. The present invention makes it a simple matter to program the VCR from the computer that runs the Personal Server. The user will typically enter the time and channel to record, or else a code corresponding to a program (such as a VCR-PLUS™ code). In a preferred embodiment, the user is also able to enter the name of the program, and the Personal Server, by interacting with a database or data source (such as a database available on the Internet), determines the program specifics. The Personal Server is sophisticated enough in its architecture to prompt the user if there is problem with the information entered, or if it cannot complete the task (for instance, if the VCR is already programmed for another program at the same time). It will also prompt the user with other status information, when it is appropriate.

Of course, the user generally will wish to program the VCR from a Remote Device rather than from the Personal Server itself. The present invention, by connecting the Remote Device to the Personal Server in a seamless fashion, makes this effectively the same task.

b. Non-Remote-Ready-Objects

Non-remote-ready Controlled Devices are those objects that typically are not remote capable. Examples of these objects include microwave ovens, dishwashers, toasters and coffee makers. Increasingly, such devices are being manufactured remote-ready. As Personal Servers become increasingly common, this trend will likely continue. For objects that are not remote-ready, a user will be able to adapt the objects for remote use with additional hardware. At the very least, such objects can be controlled with simple commands by installing remote switches such as X10™ units (see “Other objects,” below), or, failing that, at least simple on/off switches.

The programming of a non-remote-ready device is similar in implementation to the programming of a VCR outlined above. One difference though is that non-remote-ready objects tend to be more dependent on status in order to function in an appropriate manner. For instance, there should be coffee in the coffee maker or food in the microwave oven before the Personal Server activates these objects. It is partially for this reason that such objects have not been as readily adapted for remote use as some others have. Leaving a tape in a VCR and then wishing to program it later is a common desire. Leaving dirty clothes in a washing machine and washing them later is not so common. Nonetheless, the ability to do so must be convenient in some cases, such as turning a coffee machine on in the morning. As Personal Servers become more common, users will wish to take advantage of these conveniences, and thus more objects not envisioned as readily adaptable to remote use will be made remote-ready.

c. Other Objects

There are a number of other objects that can be controlled and monitored with the Personal Server. For example, simple objects such as lighting fixtures can be equipped with X-10™ control units, which can be used to turn them on and off and to dim them. Much more sophisticated objects, such as pools and Jacuzzis, environmental systems, weather stations and television cameras, among others, can be controlled and monitored with the present invention. Again, the user may well need to adapt these objects for use with the Personal Server by installing hardware attachments.

One form of Controlled Device that merits special attention is a home or office computer. Either the Personal Server itself, or a separate computer, may function as a Controlled Device when operated in connection with the present invention, operated remotely via the Remote Client to perform a variety of tasks such as sending or retrieving electronic mail, voice mail, or faxes, uploading and downloading files, and connecting to the Internet.

The types of Controlled Devices that can be incorporated into the Personal Server system are almost limitless. As one example, the system can be used to detect how many cars are sitting in the garage or driveway through the use of cameras, external sensors or chips embedded in cars. The latter is a particular cheap and simple way of bringing automobiles into the domain of the Personal Server. More sophisticated control features, such as remote car warmers, security systems or ignition devices, will become amenable to the present invention as available technology improves, and as users, vendors and inventors become more accustomed to and imaginative about such uses. One of ordinary skill in the art can imagine boundless examples. In this way, the present invention provides a broad basis for future technical development.

d. Remote Information Tasks

One of ordinary skill in the art will appreciate that remote information uses will also proliferate as technology, commercial innovation and commercial imagination develop. One current use is the transfer of computer files, such as video, spreadsheets, word processing documents and figures between the Remote Client and the Personal Server. These files may be used as part of the various control and monitoring features of the Personal Server, for example, remote viewing of images or streaming video from household cameras, or they may be entirely unrelated.

Communication can be done continuously, or in bursts, depending on need. Either the Remote Client of the Personal Server, and in some embodiments, objects in the network, can initiate and terminate communications. If there is a calculation or process that takes a great deal of time, the user may initiate the process remotely, terminate communication, and then check in from time to time to see if the process or calculation has been completed.

In one embodiment, the Personal Server can act as a pass-through communications link for the Remote Client. For instance, the user can surf the Internet remotely from the Remote Device via the Personal Server. Computational tasks and file retrieval can be done in a similar manner. The user can accomplish these tasks in real-time or else send the task to the Personal Server and then end the transmission. At some later time, when the Personal Server has completed the task or requires additional information, the Personal Server may request that communication be reestablished.

One particularly convenient use for the present invention applies to credit-card transactions. Merchants using the current invention can verify credit-card numbers by uploading them from the Remote Device (which will generally have a card reader) to the Personal Server for verification. A credit-card charge can be carried out in a similar manner. Other, transactions, financial and otherwise, are obvious to one of ordinary skill in the art.

4. Firewall Penetration

In one embodiment of the present invention, the Personal Server network system is adapted to operate with protected networks. For this embodiment, the Personal Server and Controlled Devices, illustrated in FIG. 2, are coupled over a WAN, typically the Internet. The Personal Server is protected by a network protection or security system. Such a protection mechanism is typified by a firewall that shields one network from another network (e.g., the Internet), by blocking unwanted input to the internal network. Because they provide blocking and protection functions, firewalls, proxy servers, and other types of protection schemes are all impediments to making a TCP/IP or UDP connection to a computer from a remote device. To allow devices to access computers and other resources behind a firewall, the communication system must be configured to allow the firewall to permit certain types of communication to pass through it, while still maintaining its blocking function. Embodiments of the present invention provide means to identify the presence and type of firewall and then establish communications between the Personal Server and the Controlled Devices through the firewall mechanisms.

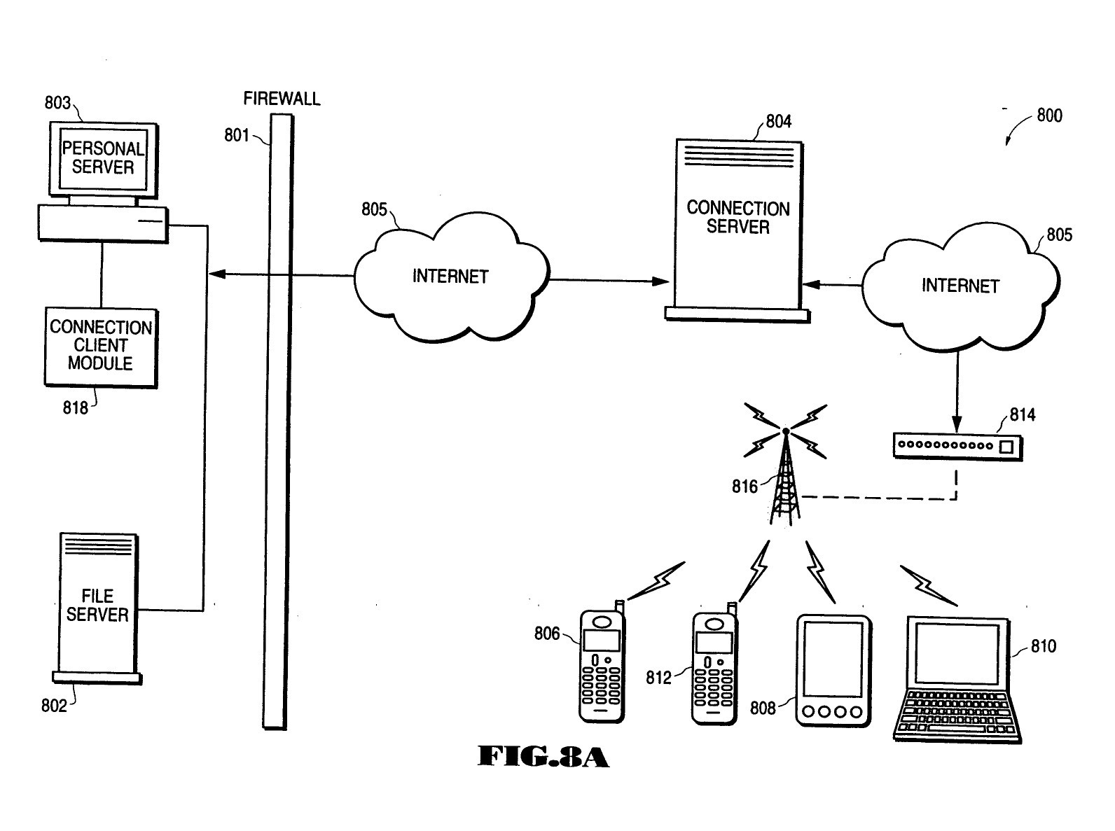

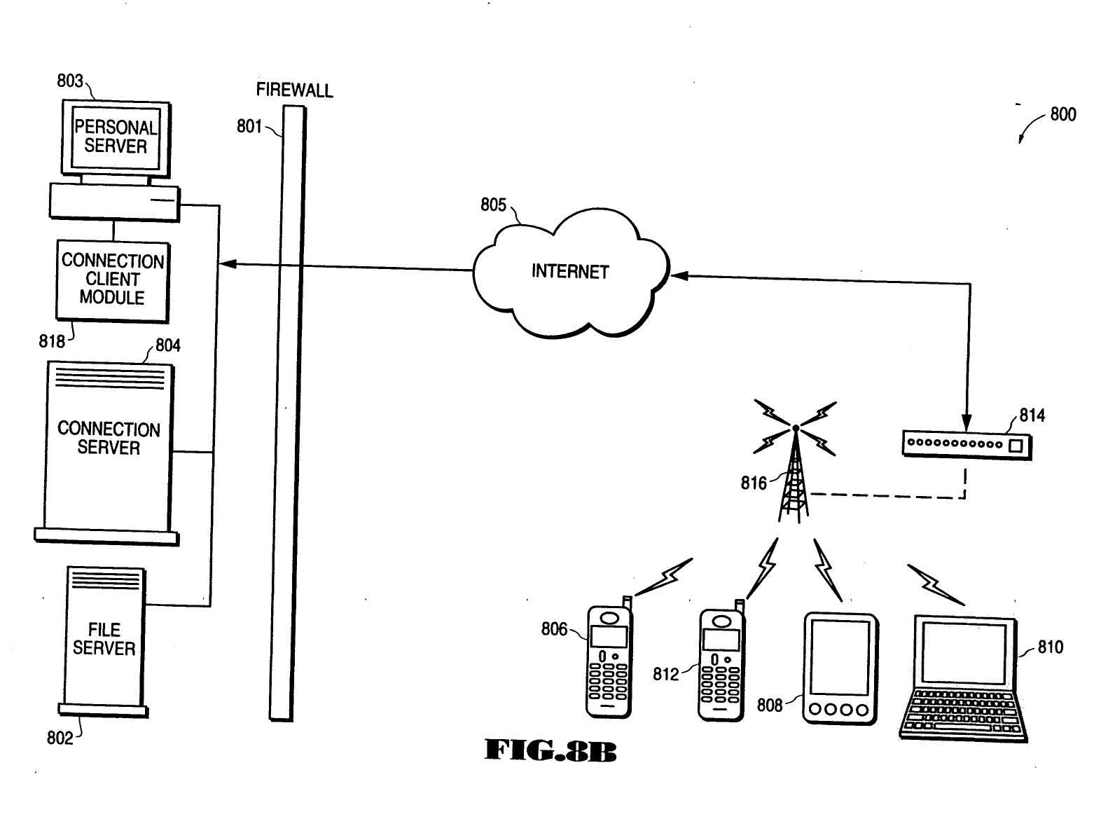

FIG. 8A illustrates a Personal Server network that includes a firewall detection and penetration scheme, according to one embodiment of the present invention. In system 800, Personal Server 803 is coupled to the Internet 805 (or other WAN) through firewall 801. Firewall 801 may be implemented as a single router or a combination of routers and server computers that perform firewall protection functions. A Connection Server 804 resides on the Internet 805. The Connection Server 805 is a trusted server that is coupled to a variety of remote devices 806-812 through direct or indirect wireless access. These remote devices may be wireless devices, such as cell phones 806, PDA devices 808, wireless computers 810, and the like, which transmit and receive data signals via transmission tower 816 through a wireless gateway 814 to the Internet 805 over wireless links. The remote devices illustrated in FIG. 8A may be Internet-enabled devices that connect to the Internet using their own internal Internet browsing abilities, such as a web browser on a laptop computer 810. Other remote devices, such as cell phone 810, may be Wireless Application Protocol (WAP) devices, or PDA devices that include built-in browser capabilities. Other remote devices include web kiosks, and WebTV systems, and the like. The remote devices may also include devices that communicate directly with the Personal Server 803 over the Internet using TCP/IP, without using a web-based interface.

The Connection Server 804 establishes a connection between the Personal Server 803 and the remote devices 806-812. In a web-based embodiment, the Connection Server 804 presents correctly formatted web pages to the remote devices and uses information from the web pages to send commands to the Personal Server 803 and to present new web pages to Internet-enabled remote devices based on information from the Personal Server 803. Thus, the Connection Server 804 provides web-serving functions that allow a remote device user to access the Personal Server 803. Firewall 801 protects the Personal Server 803 against unwanted access from the Internet, and keeps the internal network segments secure, for example between Personal Server 803 and locally networked file server 802. For the sake of terminology, the Personal Server 803 and file server 802 network is considered to be “inside” the firewall 801.

In general, the Personal Server 803 is coupled to the Internet 805 through a TCP/IP (Transmission Control Protocol/Internet Protocol) network connection. In an IP network, each computer is allocated a unique IP address. In a TCP/IP network, an IP address is usually shown in the form of an IP Address and a Port. The IP Address is a “dot” number (e.g., 123.333.5.20) and the port is a number in the range of 0 to 65,5535. Generally a computer or network element will have a single IP address and up to 64K ports. An IP Address/Port pair may be used to establish an outgoing connection from the computer, and it may be used to listen for and establish an incoming connection.

Many ports are used for standard communication functions. For instance, Port 80 is typically used to send and retrieve standard Web pages; and Port 443 is typically used to send and retrieve secure Web pages. Because there are so many ports and because different programs and applications may use these ports for different types of communications, leaving an IP address open to the Internet may leave it open to an unwanted or malicious communication from the outside. The purpose of a firewall is to impede these unwanted communications. Thus, firewall 801 in FIG. 8A acts to limit the type and range of connections to and from the user computer 804.

As illustrated in FIG. 8A, Personal Server 803 includes a client application, referred to as a “connection module” 818 that establishes a connection from inside the firewall to the Connection Server 804, and then keeps the connection open as a continuing communication conduit. The Communication Server 804 may have a corresponding “bridge module” (not shown) that transmits and receives data to the connection module 818.

Some firewalls prevent certain types of information packets, such as UDP (User Datagram Protocol) packets, from going in or going out. UDP, along with TCP is a transport protocol within TCP/IP. While TCP ensures that a message is sent accurately and in its entirety, UDP does not provide robust error correction mechanisms, and is used for data, such as real-time voice and video, where there is limited time or reason to correct errors. In one embodiment of the present invention, the system packages these packets into an allowed data stream, such as TCP/IP, and then unpacks the stream at the other end of the communication conduit. If packets are destined for blocked ports, these packets are redirected through the conduit and then sent to the correct port-when they reach the other side.

Various different types of firewalls and protection mechanisms exist. The different classes of firewalls described are IP Filtering, Network Address Translation, Proxy Servers, Stateful Firewalls, and Dynamic IP Addresses, and each poses an impediment to connectivity. The firewall penetration mechanism of the present invention can work with each type of firewall individually or any combination of these firewalls.

Because different firewalls and different proxy servers use a combination of different protocols, the firewall penetration system includes processes that determine what protocols are being used and to dynamically connect the Personal Server to the wireless network served by the Connection Server and configure the messages accordingly. To do this, upon installation, a process on the Personal Server establishes communication with the Communication Server, announces its presence and requests that the Communication Server begin a series of tests to try to connect back to the Personal Server. A series of tests is then run using communication protocols of increasing complexity until one is found that works. The Personal Server and the Connection Server then record that as the preferred method of communication between the two. The connection module 818 on the Personal Server then uses the preferred protocol to establish a connection to the Communication Server. This method thus determines whether a firewall 801 exists between the Personal Server and the Internet, and the type of firewall that exists. Firewall penetration is accomplished because it is the computer on the inside of the firewall, i.e., Personal Server 803, that initiates the connection. When the Personal Server creates a connection to the Connection Server, it announces its location (IP address), and updates its location every time it changes. In creating the connection from inside the firewall, the Personal Server formats the information using a format and protocol that the firewall will recognize and allow to pass through.

The different connection configurations in the order of increasing complexity that the connection module 818 attempts to connect to the Connection Server 804 are listed as follows:

1. No firewall or proxy server

2. Fixed IP Address (IP Filtering)

3. Dynamic IP Address

4. Network Address Translation Firewall

5. Proxy Server

6. Complex or Stateful Firewall

The processes executed by the connection module and Connection Server in establishing communication through each of these types of firewalls is provided in the description below.

a. IP Filtering

In an IP Filtering type of firewall, only certain port addresses are allowed to connect to the Internet. Usually these are port 80, for standard web page access; and port 443 for SSL (Secure Sockets Layer) and secure web page access. For this type of firewall, the Connection Server is set to listen on port 443. Thus, when the connection module of the Personal Server establishes a connection to the Connection Server, it does so over an allowed port. This is an “on-demand” type of connection in which the connection between the Connection Server 804 and the Personal Server 803 is opened only when there is data to be transmitted.

b. Dynamic IP Addresses

For dynamic IP address protection schemes, IP addresses of the connecting computer are changed with each access. That is, every time the connecting computer is given access to the Internet, it is assigned a new IP Address/Port pair, thus making it difficult to consistently locate.

For this type of connection, when the Personal Server obtains an Internet connection, the connection module registers its new IP address with the Connection Server, which logs it and uses it for subsequent connections. This way the Connection Server acts like a directory service for an outside application trying to establish an inbound connection to the user computer. Like the IP filtering system the dynamic IP address system is an on-demand system.

c. Network Address Translation (NAT) Firewalls

In a Network Address Translation type of firewall, each IP Address/Port pair on the computer behind the firewall is translated to a different IP Address/Port pair. This enables a local area network to use one set of IP addresses for internal traffic and a second set of addresses for external traffic. A NAT device located where the LAN meets the Internet makes all necessary IP address translations.

For this type of firewall, like the dynamic IP address solution, the connection module of the Personal Server registers its new address with the Connection Server. If the communication between the Personal Server and the Connection Server breaks, the Personal Server reconnects. Communication through a NAT firewall is also on-demand.

d. Proxy Servers (SOCKS 4 Proxy, SOCKS 5 Proxy, HTTP Proxy)

A proxy is a device that acts on behalf of another device. For web applications, a web proxy acts as a partial web server, in which a network client makes requests to the proxy, which then makes requests on their behalf to the appropriate web server. Proxy servers allow many computers to access the Internet through a single Internet connection, which is done by temporarily assigning a port of the Internet connection to the user computer. Unlike NAT and dynamic IP address schemes, web proxying is not a transparent operation, and must be explicitly supported by the clients. For this type of firewall, each IP Address/Port pair on the computer behind the firewall is translated to a different IP Address/Port pair. Inbound connections and UDP connections are not allowed. Only outgoing TCP/IP connections to port 80 and port 443 are allowed.

To penetrate this proxy server firewall, the Connection Server listens on port 443, the port normally used for secure web pages. The connection module of the Personal Server establishes a TCP/IP link to the Connection Server on port 443 and keeps the connection open by sending periodic bursts of data, referred to “keep alives.” If the connection is broken, the connection module opens it again. On the Connection Server side, all incoming data is packaged into a single TCP/IP stream that is sent over the conduit established by the connection module. The connection module unpacks the data on the client side, and sends the information to the appropriate ports on the Personal Server (the computer on which it is running). When the Personal Server sends information back to the Connection Server, it packages it in the same way, sends it over the conduit. The Personal Server then unpacks the data stream to send to the remote devices. At installation, the Personal Server first attempts Socks 5, then Socks 4, and then HTTP-proxy protocol.

e. Stateful Firewalls

A normal Firewall is “stateless” because it has no memory of context for connection states, and each connection through it is a new connection. A stateful firewall remembers the context of connections and continuously updates this state information in dynamic connection tables. This type of firewall monitors the information flowing through it and only allows certain types of data in certain states to pass through. Thus, if a foreign packet tries to enter the network, claiming to be part of an existing connection, the firewall can consult the connection tables. If a packet does not match any of the established connections, that packet is dropped. For example, a stateful firewall can monitor web transactions for proper HTTP formatting and proper HTTP responses. It then allows only connections of short duration, such as a web page access.

For stateful firewalls, the Connection Server is set to listen on port 443 (the HTTP port). This is the secure port for web page access, so that the firewall will not filter out its IP address. Since data that passes through this port is normally encrypted, the firewall allows all information through and cannot monitor its state. When the connection is broken by the stateful firewall, the connection module automatically re-establishes a connection to the Connection Server and keeps the connection alive as long as it can by sending periodic bursts of data, “keep alives.”

Once communication has been established between the Personal Server and the Connection Server through the firewall, the remote devices can be used to -access the Personal Server. In one embodiment, a remote device 806 transmits a login request to the Connection Server 804 via the wireless service 814. The Connection Server 804 authenticates the login, and sends a request to the Personal Server 803. The Personal Server then responds to the request, which is relayed through the Connection Server 804 to the remote device 806. At this point, the remote device, using the conduit through the Connection Server 804, has remote access and control to the Personal Server, and any resources coupled and controlled to the Personal Server, such as file server 802, and any other desktop computers or devices.

The embodiment illustrated in FIG. 8A illustrates a configuration in which the Connection Server 804 resides on the Internet. Such a configuration may be used in an Application Service Provider (ASP) scenario in which the Connection Server 804 is hosted by an ASP or other third-party entity. In an alternative embodiment of the present invention, the Connection Server 804 may be hosted in-house, that is on the same protected network as the Personal Server 803. Such a configuration, according to this alternative embodiment is illustrated in FIG. 8B. As shown in FIG. 8B, the remote devices 806-812 are coupled through the Internet 805 to a firewall protected network comprising Personal Server 803, Connection Server 804, and other resources, such as file server 802. For this configuration, the Personal Server 803 establishes communication with the Connection server 804 through connection module 818 directly over the internal LAN link. For example, upon boot-up, the Personal Server can register with the Connection Server, which is hosted by the same entity, thereby opening a communication channel. The remote devices 806-812 transmit login requests to the Connection Server 804, which authenticates the request and relays the request to the Personal Server 803.

f. Method

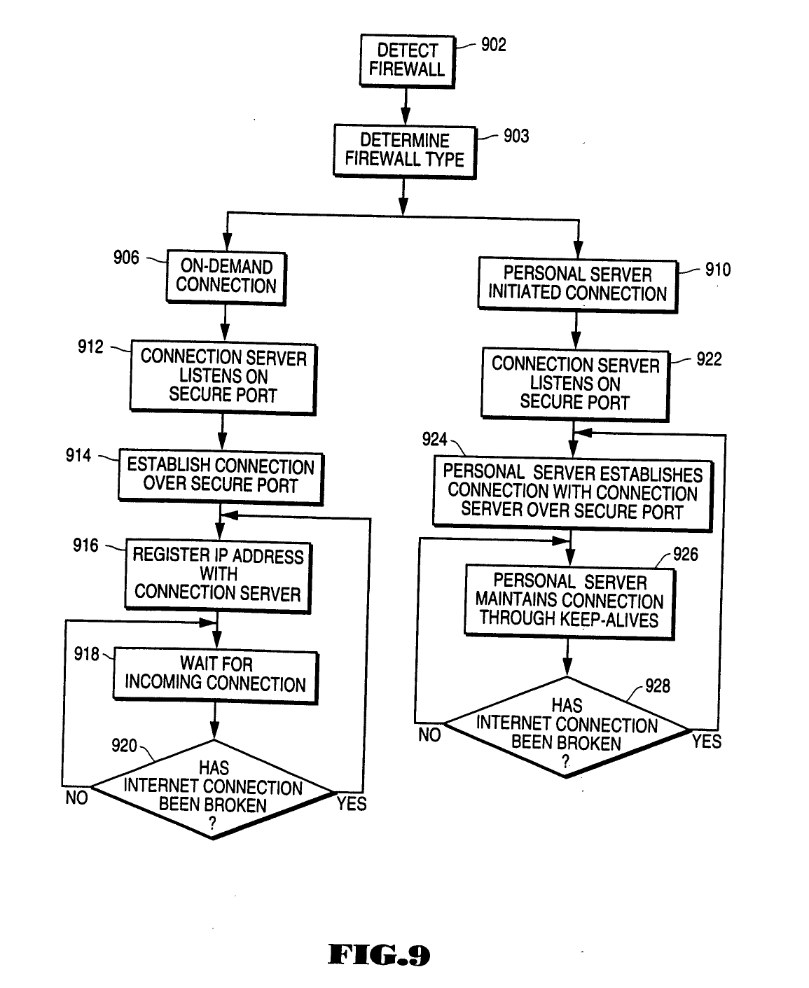

FIG. 9 is a flowchart that illustrates the method of identifying the presence of a firewall and establishing a communication conduit between a user computer and Personal Server, according to one embodiment of the present invention. The flowchart of FIG. 9 illustrates the general process steps executed by the Personal Server and Connection Server for the network illustrated in FIG. 8A to detect and circumvent the various types of firewalls described above. In step 902, the connection module in the Personal Server detects whether a firewall exists between it and the Connection Server by comparing the IP address of the machine on which the Personal Server is running to the IP address from which the connection was received. If such a firewall exists, the type of firewall is determined, step 903. In general, the types of connections to be established through any detected firewall fall into two general categories: on-demand connections 906, and Personal Server initiated connections 910.

On-demand protection connections 906 include IP filtering, dynamic IP addresses, and NAT firewalls that allow incoming connections. For these types of firewalls, the Personal Server attempts to establish a connection to the Connection Server so that the wireless remote devices coupled to the Connection Server can communicate with the Personal Server at will. The connection is initiated by the Connection Server and opened only when there is data to be transmitted between the two servers. The Connection Server listens on a secure port, typically port 443 for secure web page access, step 912. The Personal Server then establishes a connection with the Connection Server over this secure port, step 914. For this embodiment, it is generally assumed that dynamic IP addressing is used. In step 916, the Personal Server registers its IP address with the Connection Server, and then waits for incoming connections from the Connection Server, step 918. If the connection is broken, as determined in step 920, the Personal Server registers its address with the Connection Server again from step 916. In this manner, the Connection Server can always establish a connection to the Personal Server even if the Personal Server has a dynamic IP address.

Personal Server initiated connections 910 are used for proxy servers, stateful firewalls, and NAT firewalls that refuse incoming connections. For Personal Server initiated connections 910, the Connection Server listens on a secure port, e.g., port 443, step 922. The Personal Server then establishes a connection with the Connection Server over this secure port, step 924. The firewall may cause connections to be repeatedly broken between the Personal Server and the Connection Server since it cannot monitor the state of any encrypted data that is transmitted. In step 928, the process determines if the connection has been broken. If so, the Personal Server re-establishes the connection with the Connection Server, from step 924. The Personal Server then maintains the connection to the Connection Server through periodic “keep alive” signals, step 926.

Embodiments of the present invention may be used in conjunction with various encryption and authentication mechanisms to provide further security measures. For example, transmitted data may be encrypted using public key/private key and/or Secure Socket Layer (SSL) algorithms.

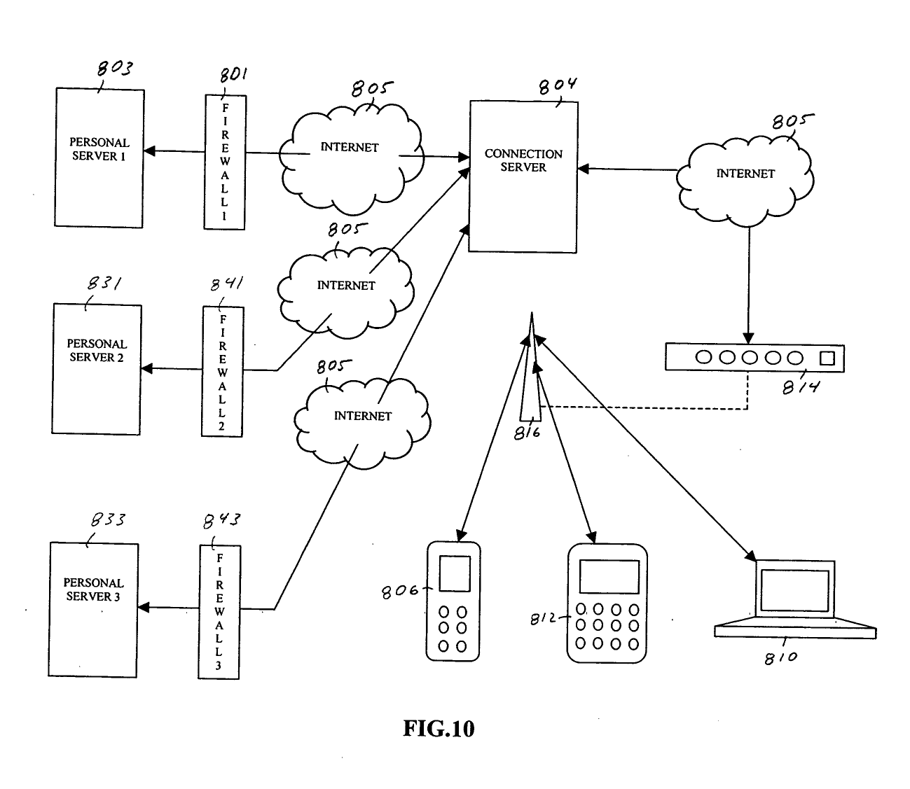

FIG. 10 illustrates a Personal Server network 900 that includes a firewall detection and penetration scheme, according to one embodiment of the present invention. The personal server network 900 is similar to the network illustrated in FIG. 8A but more clearly illustrates the plurality of personal servers 803, 831, 833 that are each protected by firewalls 801, 841, 843 and the communications through the connection server 804 to the remote devices 806, 810, 812. As discussed above, the communications server 804 acts as a directory service by connecting the remote devices 806, 812, 810 to their associated personal servers 803, 831, 833. In this illustration, remote device 806 is a cell phone that is associated with personal server 803. Remote device 812 is a PDA that is associated with personal server 831 and remote device 810 is a laptop computer that is associated with personal server 833.

In an embodiment, the remote devices 806, 812, 810 include wireless communication and have built-in browser capabilities. The remote devices 806, 812, 810 transmit and receive data signals via transmission tower 816 that is coupled to a wireless gateway 814 and the internet 805. The remote devices 806, 812, 810 can establish individual connections with their associated personal servers 803, 831, 833 through the connection server 804.

In a web-based embodiment, the connection server 804 has a directory database that includes IP addresses for the personal servers and IP addresses for the associated remote devices. When a remote device 806 transmits a command to the associated personal server 803, the connection server 804 receives the command and identifies the associated personal server 803 and transmits the command through the firewall 801 to the personal server 803. The penetration of the firewall 801 is described above with reference to FIG. 8a. If information is being retrieved, the personal server 803 transmits the information through the internet 805 to the connection server 804 which directs the information through the internet 805, wireless gateway 814 and transmission tower 816 to the remote device 806. This same procedures is followed for communications between the remote device 812 and personal server 831 and communications between remote device 810 and personal server 833. Although, only three groups of personal servers and remote devices are illustrated, it is intended that the communications server 804 will be able to properly route communications between many more remote devices and their associate personal servers.

Although embodiments of the present invention have been described in relation to particular types of firewalls, it should be noted that the firewall penetration solutions described herein can be implemented with other types of firewalls that feature similar protection mechanisms.

In the foregoing, a system has been described for providing firewall penetration between two networks through a connection server. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense. All publications and patents herein are incorporated by reference in their entirety.

What is claimed is:

1. A method of interfacing client devices coupled to a communication server that communicates with personal servers, the method comprising:
establishing communications between a plurality of client devices and the communication server that includes a request for a connection with a plurality of personal servers, wherein each of the personal servers are associated with one or more of the client devices;
establishing communications between each of the plurality of personal servers and the communication server;
transmitting a test message between the personal servers and the communication server to determine whether the personal servers are each protected by a firewall that is coupled to each of the personal servers to filter communications between each of the personal servers and the communications server;
transmitting a series of messages between the communication server and the personal servers using communication protocols of increasing complexity to identify the types of firewalls, if it is determined that the firewalls exist between the communication server and the personal servers;
utilizing the communication protocol corresponding to the type of each of the firewalls identified to establish a persistent communications connection between the communication server and the personal servers in an on-demand manner;
sending messages as needed from the personal servers to the communication server in order to maintain the persistent communication connection between the personal servers and the communications server;
registering network addresses for the personal servers with the communication server that allows the client devices to make an unambiguous connections to their associated personal servers.

2. The method of claim 1 further comprising the steps of:
re-establishing communication from the user computer to the server computer by the user computer if the communication is unintentionally broken;
using communication ports for communication between the personal servers and the communication server that are usually reserved for carrying encrypted data so that the firewalls will not detect unwanted data transmissions, and
maintaining persistent communication between the personal servers and the communication server by transmitting periodic non-traffic signals from the personal servers to the communication server so that a communication path to the personal servers is always available for the first client device.

3. The method of claim 2 wherein the communications protocols include, in order of increasing complexity: no firewall present, fixed address firewall, dynamic address firewall, proxy server protection, network address translation firewall, and stateful firewall.

4. The method of claim 1 wherein the one or more wireless client devices comprises one of: a personal computer, handheld personal digital assistant, and networkable cellular phone.

5. The method of claim 4, wherein the wired or wireless network comprises a TCP/IP network and data transmitted over the network comprises one of: computer text data, audio data, and video data.

6. The method of claim 1 wherein the first personal server and the communication server are coupled through a bi-directional communications network that comprises the Internet.

7. A system comprising:
a plurality of client devices;
a communication server coupled to a network coupling the plurality of client devices;
a plurality of personal servers including a connection module for communicating with the communication server, wherein each of the plurality of personal servers corresponds to at least one of the plurality of client devices;
a plurality of firewall protection mechanisms, wherein each firewall mechanism is coupled to at least one of the personal servers to filter communications between the communication server and each of the personal servers to prevent unwanted network access from the communication server to the personal servers;
wherein the connection module is configured to initiate transmission of a series of messages between the communication server and the personal servers using communication protocols of increasing complexity to identify the type of firewall that exists, and further configured to register an address and identifying information of the communication server with the personal servers if the firewall causes the address of the communication server to change upon each new connection with the personal servers, if there is no firewall or if the firewall allows outside connections through specific IP ports, the communication server uses registered address stored in the personal server to create direct connection on-demand for the client device.

8. The system of claim 7 wherein the connection module is further configured to re-establish communication from the communication server to the personal servers by the communication server if the communication is unintentionally broken, and maintain the communication between the communication server and personal servers by transmitting periodic non-traffic related signals from the communication server to the personal servers.

9. The system of claim 8 wherein the communications protocols include, in order of increasing complexity: no firewall present, fixed address firewall, dynamic address firewall, proxy server protection, network address translation firewall, and stateful firewall.

10. The system of claim 7 wherein the one or more networked client devices comprises at least one of: a personal computer, a handheld personal digital assistant, and a networkable cellular phone.

11. The system of claim 10, wherein the network comprises a TCP/IP network and the data transmitted over the network comprises one of: computer text data, audio data, and video data.

12. The system of claim 11 wherein communication server and personal servers are coupled through a bi-directional communications network that comprises the Internet.

13. The system of claim 11 wherein the communication server is remotely coupled to each of the plurality of client devices over a remote control protocol, and provides control and monitoring functionality over the plurality-of-client devices.

14. A method for interfacing a plurality of client devices through a communication server to a plurality of personal servers through network connections that each include a firewall, the method comprising the steps of:
determining if each of the connections between the communication server and the personal servers initiated by the communication server or by the personal server;
causing the communication server to listen for connections to the personal servers over a secure ports accessible by the communication server;
establishing connections between the communication server and each of the personal servers that allow the client devices to communicate with the personal servers associated with each of the devices over the secure ports;
registering a network address of the personal servers with the communication server, if the connection between the communication server and the personal server is initiated by the communication server; and
re-registering the network address of the personal server with the communication server if the connection established between the communication server and the personal server is broken.

15. The method of claim 14 wherein each of the firewalls comprises one of: an address filtering firewall, a dynamic address firewall, and a network address translation firewall that allows incoming connections to the personal servers.

16. The method of claim 14, wherein if the connection between the first server computer and the second server computer is initiated by the second server computer, the method comprises the steps of:
causing the communication server to listen for a connection to each of the personal servers over secure ports accessible by the communication server;
establishing connections between the communication server and each of the personal servers over the secure ports;
determining whether any of the connections have been broken;
re-establishing any broken connections between the communication server and the personal servers; and
transmitting periodic non-data signals from the personal servers to the communication server to maintain the connections.

17. The method of claim 16 wherein each of the firewalls comprises one of: a proxy server firewall, a stateful firewall, and a network address translation firewall that refuses incoming connections to the personal server.

18. The method of claim 14 wherein the communication server is coupled to the client devices over wireless network links.

19. The method of claim 14 wherein the communication server and the personal servers are coupled through a bi-directional communications network that comprises the Internet.

20. The method of claim 14 wherein the communication server is remotely coupled to each of the plurality of client devices over a remote control protocol, and provides control and monitoring functionality over the plurality-of-client devices.
